(19) United States
(12) Patent Application Publication
(10) Pub. No.: US 2007/0137420 A1
(43) Pub. Date: Jun. 21, 2007

(54) Method and device for self-contained inertial vehicular propulsion

(76) Inventor: Gottfried J. Gutsche, Mississauga (CA)

Correspondence Address: Mr G. Gutsche, 6816 Estoril Rd., Mississauga, ON, L5N 1N1, CA

(21) Appl. No.: 11/544,722

(22) Filed: Nov. 29, 2006

(30) Foreign Application Priority Data
Nov. 16, 2005 (CA) 2526735

(51) Int. Cl. H02K 7/02

(52) U.S. Cl. 74/572.1

(57) ABSTRACT

A novel method and device for self-contained inertial vehicular propulsion using the combined effort of linear and rotational kinetic energy. The propulsion device containing pairs of flywheels with parallel axial orientation, opposite rotation and opposite alternate cyclic linear movement in the direction of vehicular travel. Kinetic energy is supplied to the flywheels with integral motor-generators means while at the same time the motor-generator means is connected to a rotational-to-reciprocal transmission means causing the alternating cyclic movement of the flywheels and supplying kinetic energy output for the propulsion of the vehicle. The formulation of the rotational-to-reciprocating transmission means allows an accumulation of kinetic energy into the motor-generator means rotational kinetic energy without causing a negative reaction force, due to the governing effect of the flywheels linear inertia in a governing negative feedback loop. The accumulated energy is then used as the propulsion energy,

### FIELD OF THE INVENTION

The present invention relates to a device and method for developing a self-contained propulsion force in a predetermined direction, using the combined effort of rotational and linear inertia of pairs of flywheels. The use of power-strokes for every half cycle of the device delivers a high degree of thrust yield. Alternating flow of kinetic energy to the motor-generators delivers a high degree of efficiency. Electro-mechanical damping elements recycle the alternating flow of kinetic energy.

### BACKGROUND OF THE INVENTION

The earliest example of using the combined effort of rotational and linear kinetic energy to produce a large linear force is the medieval catapult called “Tre'Bucher”. The action of this catapult was so effective because of the combined effort of linear and rotational kinetic energy. Previous known patents describing self contained inertial propulsion devices using linear moving flywheels or other inertia elements are: U.S. Pat. No. 3,492,881 from Auweele, U.S. Pat. No. 3,863,510 from Benson, U.S. Pat. No. 4,242,918 from Srogi, U.S. Pat. No. 4,712,439 from North, U.S. Pat. No. 5,890,400 from Oades, U.S. Pat. No. 69669987 from Laul. Aus. Pat. No. AT408649B from Gruebel. Jap. Pat. No. 7156899 from Tetsuo. and Germ. Pat. No. DE3512677 from Urmolt. The before mentioned devices, while each an important contribution in the art of inertial propulsion, develop comparatively low energy propulsion forces or high degree of vibration compared to the energy input and size of the machines. The before mentioned devices also lack directional control. The listed patents do not use kinetic energy flow in both directions of linear flywheel movement. The listed devices lack the use of logic timed alternating energy flow of motor-generators to generate an unimpeded reciprocal motor-generator to flywheel torque in an advantageous force vector projection. In addition, the use of flywheels with integral motor-generators combined with central-shaft mounted rotational-to-reciprocating transmission means is also a new development in the field. None of the patents use the advantage of timed damping means and the opposing alternating linear movement of pairs of flywheels, which has the advantage of neutralising vibrations caused by the moving masses and allows for a more continuous form of propulsion energy. A further improvement to the prior art is the use of motor-generators and damping means drivers connected to logic interfaces which maximises their operation with precision.

### BRIEF SUMMARY OF THE INVENTION

It is the objective of the present invention to provide a self contained inertial propulsion device with directional control.

It is another objective of the invention to provide an inertial propulsion device with a high degree of efficiency.

It is still another objective of the invention to provide an inertial propulsion device with a low vibration characteristic.

It is a further objective of the invention to use advanced motor control and engineering techniques for the advancement of inertial vehicular propulsion.

Other features and advantages will be apparent from the following description with accompanying drawings.

### DESCRIPTION OF THE DRAWINGS

FIG. 1 is the top view of the mechanical representation of the propulsion device. The format is in wire-frame format for unimpeded logical perusal.

FIG. 2 is the side view of the propulsion device with the supporting frame cut open.

FIG. 3 is the top view of the propulsion device with a continuous running drive motor, external to the flywheel assemblies.

FIG. 4 is the side view of the propulsion device including a timing wheel means and timing motor.

FIG. 5 is the graphical representation of the motor-generator means drive pulses generated by the method of timing of the logic control means for continuous rotating motor-generator means.

FIG. 6 is the graphical representation of the motor-generator means drive pulses for an alternating rotation of the motor-generator means.

FIG. 7 is the graphical representation of the resultant propulsion forces when energy absorbent damping is applied under the method of logic control.

FIG. 8 is the graphical representation of the force vector flows.

### DETAILED DESCRIPTION OF THE PREFERRED EMBODIMENT

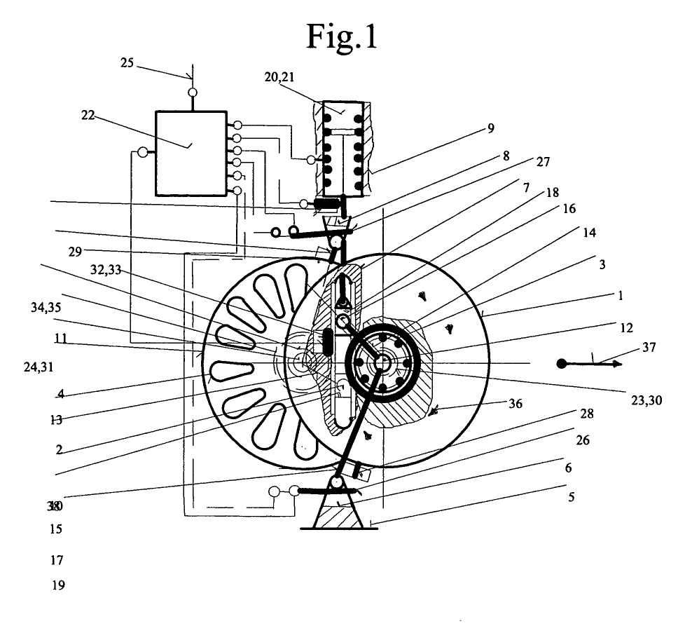

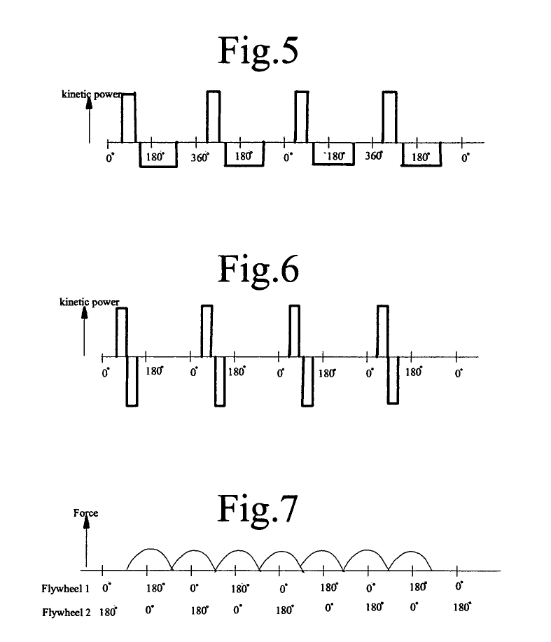

Referring to FIG. 1, the self-contained propulsion device comprising pairs of flywheels, 1 and 2, with parallel axial orientation, opposite direction of rotation and opposite alternating linear movement. Opposite alternating linear movement of the pair of flywheels accomplishes a smoothing of propulsion forces. The device can also operate with the pairs of flywheels moving in simultaneous alternating linear motion, which propels the device more in individual strokes than in continuous motion. The opposite direction of rotation accomplishes the cancelation of rotational forces, which prevents the turning of the device around its axis. The turning action, however, is used to steer the device by varying the rotational parameters of the flywheel drives. The pair of flywheels 1 and 2, each contain integral motor-generator rotor means 3 and 4, forming integral assemblies. These motor-generator means can be of different types of technologies, for example, a pneumatic vane motor-pump or a hydraulic gear motor-pump. For illustration, an electrical motor-generator armature with the current carrying conductors and field magnets is shown. The side-wall of the flywheel 1, is cut open to reveal the motor-generator means within the flywheel. The motor-generator means supplies kinetic energy pulses to the flywheel assemblies, causing the rotation and progressively changing alternating linear movement. The progressively changing linear movement is the source of dynamic back-rest for the unimpeded exertion of the kinetic propulsion energy, which is fully explained in FIG. 5, 6,7,8. The supporting frame 5, of the propulsion device is also cut away from the attachment point 6,7,8 and 9 for unimpeded view of the active working elements. The propulsion device further comprises two guidance means 10 and 11, which give each flywheel assembly substantial linear freedom of movement in direction of vehicular travel. For the present embodiment, swing-arms 10 and 11 are depicted, but many other technologies are suitable to guide the flywheels in linear motion. The swing-arms contain flywheels 1 and 2 on the moveable wrist-end and pivot at the socket-end 6 and 8. The flywheels 1 and 2 rotate around the central shaft 12 and 13, by means of rotational bearings, while the integral motor-generator rotor means is mounted co-centrically on the central shafts 12 and 13. The central shaft is contained on the wrist-end of the swing-arm by means of a rotational bearing. The propulsion device further comprises pairs of rotational-to-reciprocating transmission means, which includes the ex-centric members 14 and 15, which are mounted on each central shaft ex-centrically in relation to the flywheel assemblies. The rotational-to-reciprocating transmission means further includes the wrist-pins 16 and 17, which are mounted on the opposite end of the ex-centric members, the linear bearings 18 and 19 and the damping means 20, 21. The central shaft mounted ex-centric members 14 and 15, represent the rotational input means, as well as the reciprocating output means of the rotational-to-reciprocating transmission means. The rotational-to-reciprocating transmission means gives the flywheels an alternating opposing movement and is therefore a rotational/reciprocating input/output means. The kinetic energy output means of the rotational-to-reciprocating transmission means is represented by the wrist-pin contained in the linear bearing. The linear bearing 18 and 19, are mounted on the supporting frame 5, perpendicular to the flywheels axis and central to the guidance means. The kinetic energy output means of the rotational-to-reciprocating transmission means acts against the vehicle through the linear bearings 18 and 19, which represents the entrance point of propulsion energy into the vehicle. A further improvement to the ex-centric member is the variation of the length of the ex-centric members 14 and 15. The ex-centric member mounted with a wrist-pin contained in a linear bearing is shown in FIG. 1. Many other technologies can be adapted with the same characteristics. The propulsion device further comprises a power-supply and logic control means 22, which contains the logic control means that times and maximises the efficiency of the working components. For the simplest form of the device, power commutators 23 and 24 mounted respectively, to central shafts 12 and 13, and are able to supply timed power drive pulses to the motor-generator means. The logic control means has a command and control input 25 for speed and directional control of the vehicle. The method of directional control is accomplished with the differential variation of the duration and angle parameters of the motor-generator drive pulses. Power commutator 26 and control commutator 27, supply power and control information to the flywheel assemblies. The rotational position and angular speed of the flywheels 1 and 2, are sensed with the encoders 28 and 29. The rotational position and angular speed of the motor-generator means is sensed with encoders 30 and 31. The drive pressure exerted by the linear bearings 18 and 19, is sensed with pressure sensors 32 and 33. The position and linear speed of the damping means 20 and 21, is sensed with sensors 34 and 35. The damping means dampens and assists the movement of the flywheel assemblies under control of the logic control means. The directional arrow 36, indicates the continuous rotational direction of the flywheels, which is indicated in clockwise direction but can be in counter-clockwise direction, which then reverses all other directions including the propulsion direction. The directional arrow 37, indicates direction of vehicular travel. The imbedded electromagnetic poles 38, imbedded in the sidewalls of the flywheel 1 and 2, are used for absorbing excess rotational and linear kinetic energy from flywheels 1 and 2. The action of the imbedded electromagnetic poles 38, acting reciprocally between flywheels 1 and 2, has no negative influence on the propulsion force and returns excess kinetic energy of the flywheels 1 and 2, back to the power-supply 22.

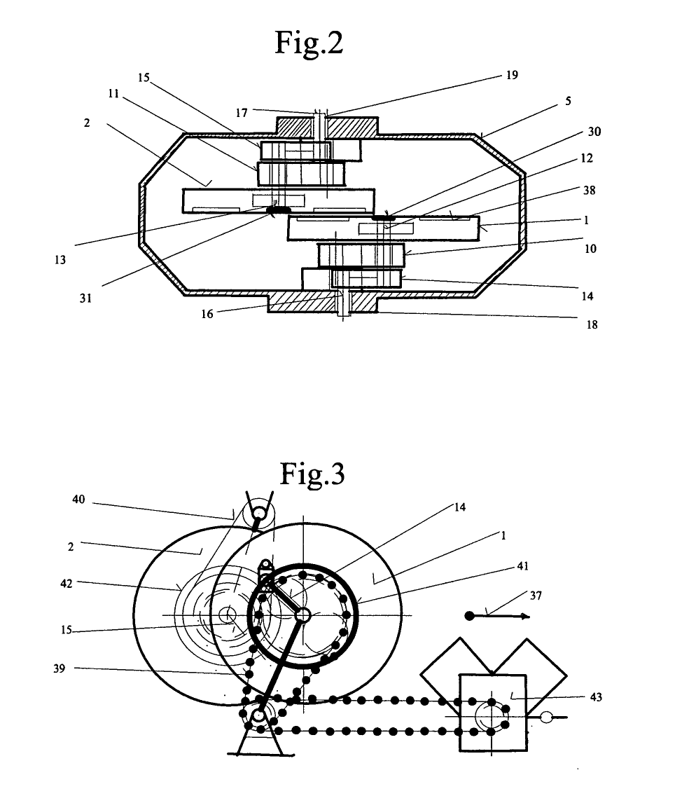

Referring to FIG. 2, which depicts the side view of the propulsion device with the supporting frame 5 cut open. The cut view of the propulsion device reveals the flywheels 1 and 2, the guidance means 10 and 11, the central shafts 12 and 13, and the motor-generator means encoders 30 and 31. The propulsion device depicted in FIG. 2 also shows the members of the variable rotational-to-reciprocating transmission means, which includes the wrist-pins 16,17, which are mounted on the ex-centric members 14 and 15 and the linear bearings 18 and 19. FIG. 2 further indicates the imbedded electromagnetic poles 38, which are imbedded in flywheels 1 and 2.

Referring to FIG. 3, which depicts the top view of the propulsion device with the rotational transmission means 39 and 40, for supplying rotational kinetic energy to the flywheels 1 and 2. The differential transmission means 41,42, distributes the rotational kinetic energy reciprocally into the ex-centric members 14,15, and into the flywheels 1 and 2. The timing, clutch and buffer means 43, times and buffers the rotational kinetic energy flow to the flywheels 1 and 2. This arrangement allows for the use of a continuous running drive motor, typically an internal combustion motor.

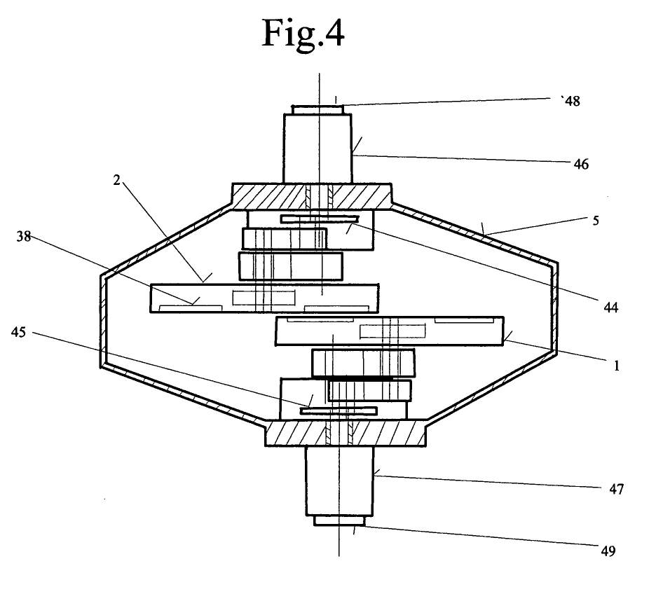

Referring now to FIG. 4, which represents the propulsion device with timing wheel means 44 and 45, for a kinetic output means of the rotational-to-reciprocating transmission means. The timing wheel means is mounted on the timing motors 46 and 47. The timing motors are mounted on the supporting flame 5, perpendicular to the flywheel assemblies axis and central to the guidance means. The timing wheel means have the purpose of timing and assisting the alternating motion of the flywheel assemblies, according to the logic control means. The timing motor shaft has an encoder or power commutator 48 and 49, attached for the purpose of timing the motor-generator energy pulses.

Referring now to FIG. 5, which depicts the graph of the motor-generator means alternating drive pulses, for the continuous rotation mode of the motor-generator 3 in FIG. 1. The graph depicts the drive pulses for the motor-generator rotor means. The motor-generator rotor means drive pulses start between 20-90 arc degrees, for positive drive, which drives and accelerates the flywheel 1, in the clockwise direction and drives the motor-generator rotor 3, in the counter-clockwise direction. During this angular acceleration, rotational kinetic energy is accumulated in the motor-generator means 3 and 4, which is called accumulation phase. The drive phase is accomplished by the angular de-acceleration of flywheels 1 and 2, and the accompanying de-acceleration of the motor-generator rotor means 3 and 4, which occurs between 90-270 arc degrees, which accelerates the linear inertia of the flywheels assemblies opposite of vehicular travel, driving the vehicle forward. The drive-phase effectively converts the rotational kinetic energy of the motor-generator rotor into linear kinetic energy of the vehicle. The drive phase also restores the unused kinetic energy back into the power-supply. The drive phase has a lower intensity because kinetic energy must remain in the motor-generator rotor means 3, to complete the rotational cycle.

Referring now to FIG. 6, which depicts a graph of the motor-generator means alternating drive pulses for oscillatory motor-generator rotor rotation. The oscillatory rotation mode, delivers a more powerful propulsion force, because a maximum drive can be applied at the drive phase 90-180 arc degrees. The drive phase also reverses the rotation of the motor-generator rotor means, to start a new accumulation phase at 180 arc degrees, but in the reverse direction. The damping action is less effective in this mode.

Referring now to FIG. 7, which depicts a graph of the typical resulting propulsion force generated by the pairs of flywheels 1 and 2. The propulsion force, starts to develop from the inertia elements during the power phase, past 90 arc degrees; when the combined linear inertial reluctance of the flywheel assembly and the accumulated rotational kinetic energy of the motor-generator rotor, invest energy into the forward motion of the vehicle.

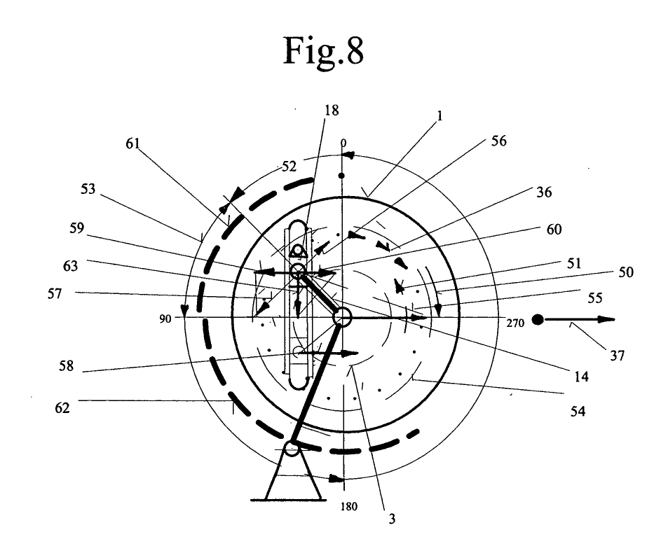

Referring now to FIG. 8, which depicts the vector parameters in correlation to the angular rotation of the motor-generator rotor 3. The directional arrow 50, indicates the angular acceleration of the flywheels. The directional arrow 36, indicates the continuous rotational direction of the flywheel 1, which is in a clockwise direction. The directional arrow 51, indicates the de-acceleration direction of the flywheel. The rotational direction 52, indicates the rotation of the motor generator means 3. The vector angle 53, between the position of the ex-centric member 14 and the right angle of the linear bearing 18, determines the instantaneous acceleration/de-acceleration characteristic of the linear flywheel inertia, following a sinusoidal motion. The centre line of mass moment of inertia is indicated with arrow circle 54. The vector triangle 56, is the instantaneous representation of the vector forces, for the indicated vector angle 53. The motor-generator 3 torque, acting against the reluctance of the flywheel 1 rotational inertia, generates the reciprocal tangential force vector couples 56 and 57. Force vector 58, is the main driving force for the inertial propulsion device during the drive phase 62. The tangential vector 57, generated between 20-90 arc degrees, is the main source of kinetic energy for the self-contained inertial propulsion device and is unimpeded. The kinetic energy is accumulated from 20-90 arc degrees in the motor generator rotors rotational inertia and is called the accumulation phase 61. The accumulated kinetic energy is then released during the drive phase 62, from 90-230 arc degrees. The accumulated kinetic energy is used to accelerate the linear inertia of the flywheel assemblies, in opposite direction of vehicular travel, thereby investing net linear kinetic energy into the vehicle in direction of vehicular travel, driving the vehicle forward. The excess linear kinetic energy induced into the flywheel assembly during this reciprocal action is then absorbed by the imbedded electro-mechanical poles, between 180 and 270 arc degrees, preventing a loss of forward drive for the reversal of alternating motion. This method of self contained inertial propulsion depicted in FIG. 2, therefor becomes apparent, because the force vectors 59 and 60 are opposing, neutralising the main source moment of force tangential vector 57, for any reaction force opposite of vehicular travel direction; the force vector 57, is at the same time, inducing rotational kinetic energy into the motor-generator rotor means at an ever increasing rate, causing the kinetic energy accumulation phase 61. The reason that the main source moment of force is not acting as an opposing force to vehicular travel, is the increasing linear de-acceleration rate of the flywheel assemblies linear inertia, up to the reversal of flywheel assemblies linear sinusoidal movement at 90 arc degrees. The de-acceleration represented by force triangle 55, generates force vector 63, which generates force vector 60, which opposes force vector 59. This progressive increasing linear de-acceleration of the flywheel assembly's linear inertia during the accumulation phase, acts as a governing influence, returning any increase in linear kinetic energy instantaneously back into the rotational energy of the motor-generator rotor means, which represents a governing negative feedback loop.

While I have shown and described a preferred embodiment of my invention, if will be apparent to those skilled in the art that many changes and modifications may be made without departing from my invention in its broader aspect. I therefore, intend the appended claims to cover all such changes and modifications as fall within the true spirit and scope of my invention.

I claim:

1. A device for self contained inertial vehicular propulsion in a predetermined direction comprising:
a supporting frame;
one or more independent pairs of guidance means with associated moveable members mounted inside the supporting frame;
one or more pairs of flywheels with parallel axial orientation, opposite rotation and opposite alternating linear movement, where each flywheel is contained on the moveable member of the guidance means, giving the flywheel substantial linear freedom of alternating movement in the direction of vehicular travel and freedom of rotation in relation to the vehicle;
a central shaft in the centre of each said flywheel, giving the flywheel freedom of rotation around the central shaft by means of a rotational bearing, while at the same time, the central shaft also has freedom of rotation in relation to the guidance means by means of a rotational bearing;
a motor-generator rotor means, which is mounted co-centrically on the central shaft, forming an integral flywheel motor-generator assembly for supplying and receiving alternating rotational kinetic energy pulses to and from the flywheel assemblies;
a rotational-to-reciprocating transmission means; having
a rotational/reciprocating input/output means; and
a kinetic energy output means;
the rotational/reciprocating input/output means is mounted to the central shaft and therefore is fixed to the motor-generator rotor means, the rotational/reciprocating input/output means is moving in an alternating reciprocating motion, while the kinetic energy output means is acting against the vehicle, representing the entrance points for the vehicles propulsion energy;
the method comprising the steps of:
the motor-generator rotor means supplying alternating rotational kinetic energy pulses to and from the flywheels, which is generating a reciprocal torque in the motor-generator rotor means, the reciprocal torque in the motor-generator rotor means is unimpeded in relation to the supporting frame;
the reciprocal torque causes an accumulation phase, which accumulates rotational kinetic energy in the motor-generator rotor means rotational inertia, to be used as the main source of kinetic energy for the vehicular propulsion during the drive phase;
the accumulation phase occurs during the flywheel motor-generator assembly's linear travel in direction of vehicular travel when approaching the alternating directional reversal of movement;
the rotational-to-reciprocating transmission means transmits the accumulated kinetic propulsion energy into the vehicle during the drive phase, which starts during the beginning of the flywheel motor-generator assembly's travel in opposite direction of vehicular travel;
the drive phase releases the accumulated rotational kinetic energy into the linear kinetic energy of the flywheel motor-generator assembly, and at the same time into the vehicle, causing the vehicular propulsion through the kinetic energy output means of the rotational-to-reciprocating transmission means, thereby using the combined rotational kinetic energy of the motor-generator rotor means, as well as linear kinetic energy of the flywheel motor generator assembly;
during the accumulation phase, no substantial force opposite the direction of vehicular travel is induced into the vehicle for any rotary kinetic energy flowing into the rotational inertia of the motor-generation rotor means due to the governing influence of the flywheel assembly linear inertia;
during the accumulation phase, the flywheel motor-generator assemblies linear inertia absorbs the rotational kinetic energy from the motor-generator rotor means and at the same time, at an increasing rate, releases the linear kinetic energy back into the motor-generators rotor means in form of rotational energy, thereby negating any opposing force in the opposite direction of vehicular travel while actively accumulating rotational kinetic energy into the motor-generator rotor means rotational inertia;
the method therefore employs a governing negative feedback loop.

2. A device as claimed in claim 1, in which the rotational-reciprocating transmission means comprises:
an ex-centric member;
a wrist-pin; and
a linear bearing;
the ex-centric member has a length, one end of the ex-centric member is mounted on the central shaft, which represents the rotational input and at the same time the reciprocating output of a rotational-to-reciprocating transmission means, the opposite end of the ex-centric member contains the wrist-pin, which engages in the linear bearing mounted on the supporting frame perpendicular to the flywheel axis and central to the guidance means, the linear bearing represents the entrance point of vehicular kinetic propulsion energy into the vehicle.

3. A device as claimed in claim 1, in which the supporting frame further comprises:
a power-supply means for supplying power to the motor-generator means;
a power-commutator means, mounted on each central shaft, for timing to the motor-generator means alternating energy pulses.

4. A device as claimed in claim 1, in which the pair of flywheels further comprises
a plurality of electromagnetic poles, imbedded in each flywheel side-wall, facing each flywheel, for the purpose of absorbing excess rotational kinetic energy from the flywheel in reciprocal fashion and returning the energy back to the power-supply.

5. A device as claimed in claim 3, in which the power-supply means further comprises
a logic control means, for the method of maximizing the timing of the alternating power pulses.

6. A device as claimed in claim 4, in which the central shaft en-gages with an encoder to sense the rotational speed and position of the motor generator rotor means for the input into the logic control means, for the method of maximising the timing of the alternating kinetic energy pulses.

7. A device as claimed in claim 5, in which the rotational-to-reciprocating transmission means further comprises:
a damping means; and
a connecting rod;
the connecting rod connects the kinetic energy output means to the damping means, for the method of moderating vibrations and guiding the flywheel motor-generator means according the logic control means of claim 5.

8. A device as claimed in claim 7, in which the damping means comprises an electromechanical damping means with the ability to restore power to the power-supply.

9. A device as claimed in claim 8, in which the kinetic energy output means further includes:
a pressure sensor for sensing the instantaneous forward propulsion force for input into the logic control means.

10. device as claimed in claim 4, in which the guidance means further comprises an encoder for the sensing of the position and rotational speed of the flywheel, for input into the logic control means for
the method of timing and maximizing the alternating kinetic energy pulses.

11. A device as claimed in claim 10, in which the logic control element further comprises
a command and control input for speed and directional control of the vehicle, further comprising:
the method of varying the timing and the power levels of the kinetic energy pulses to the pairs of motor-generator rotor means in a differential fashion.

12. A device as claimed in claim 1, in which each guidance means comprises
a swing-arm, the socket-end of the swing-arm is contained on the supporting frame and the wrist-end of the swing-arm is containing the central shaft by means of a rotational bearing.

13. A device as claimed in claim 12, further comprising:
a differential transmission mounted centrally on each central shaft for delivering kinetic energy reciprocally to both, the flywheel and the rotational/reciprocating input/output means, thereby forming an integral flywheel differential-transmission assembly;
a rotational transmission means mounted centrally on each socket-end of the swing-arms for transmitting rotational energy to the flywheel assemblies;
a timing, clutch and buffer means, connected to the rotational transmissions means for delivering timed kinetic energy pulses to each flywheel assembly according to the logic control means of claim 5;
a continuous running motor for supplying rotational energy to the timing, clutch and buffer means.

14. A device as claimed 13, wherein the rotational transmission means comprises a chain drive.

15. a device as claimed 13, wherein the rotational transmission means comprises
a shaft and gear drive.

16. A device as claimed in claim 13, in which the differential transmission means comprises a differential fluid drive.

17. A device as claimed in claim 2, in which the length of the ex-centric member is slide-able variable.

18. A device as claimed in claim 1, in which the kinetic output means comprises:
a timing wheel means; the timing wheel means is mounted on
a timing motor;
the timing motor is mounted on the supporting frame, perpendicular to the flywheel axis and central to the guidance means, for the purpose of timing and assisting the alternating movements of the flywheel assemblies, according to the logic control means of claim 4.

19. A device as claimed in claim 17, in which the timing motor is further having
a power commutator mounted on the motor shaft, for the purpose of timing the motor-generator means kinetic energy pulses.

20. A device as claimed in claim 1, in which the motor-generator means comprises an electrical motor-generator.

21. A device as claimed in claim 1, in which the motor-generator means comprises a fluid motor-pump.

22. A device as claimed in claim 18, in which the timing wheel means comprises a timing crank.

23. A device as claimed in claim 1, in which the guidance means comprises a linear bearing.

24. A device as claimed as in claim 1, in which the guidance means comprises a linear slide.

25. A device as claimed in claim 1, in which the pair of flywheels move in simultaneous alternating linear motion and opposite rotation.
